(19) United States
(12) Patent Application Publication
(10) Pub. No.: US 2003/0220807 A1
(43) Pub. Date: Nov. 27, 2003

(54) Automated method and system for managing and/or transferring real estate information

(76) Inventors: Kevin Hoffman, Gaithersburg, MD (US); Jim Anzalone, Ashburn, VA (US); Chris Cormack, Ashburn, VA (US)

Correspondence Address: FLESHNER & KIM, LLP, P.O. BOX 221200, CHANTILLY, VA, 20153, US

(21) Appl. No.: 10/310,982

(22) Filed: Dec. 6, 2002

Related U.S. Application Data
(60) Provisional application No. 60/382,387, filed on May 23, 2002.

(51) Int. Cl. G06F 17/60

(52) U.S. Cl. 705/1; 707/104.1

(57) ABSTRACT

In the real estate business, in order to keep track of the activities involved in selling, buying, or leasing a property, a real estate information managing and transferring system and method have been developed. In an embodiment of a real estate transaction system of the invention, several modules have been communicatively coupled to provide a complete and reliable system of tracking buyers' and sellers' activities and keeping a Realtor informed and prepared at all times. The real estate managing and transferring system can be made accessible by users, such as Realtors, and can include a host server with communicatively adapted parts to manage and transfer real estate information.

The application claims priority to U.S. Provisional Application No. 60/382,387, filed May 23, 2002, the entire disclosure of which is hereby incorporated by reference.

### BACKGROUND OF THE INVENTION

1. Field of the Invention

This invention relates generally to a real estate transaction system that allows Realtors and clients to create, access and modify information regarding real estate transactions.

2. Background of the Related Art

A considerable amount of time is spent every day keeping track of important information such as due dates and appointments. Both in the government and the private sector, methods of keeping track of one's day-to-day operations are constantly improving in order to streamline and improve both the functionality and efficiency of methods for managing and transferring information.

Among the most deadline sensitive business sectors is the real estate sector. Realtors, who are agents hired by parties to a real estate transaction and for purposes of this disclosure may include real estate agents, brokers, office administrators or real estate support staff, spend considerable amounts of time keeping track of real estate transaction information, such as due dates, property data and client data. If a Realtor fails to properly track a real estate transaction, it may cause the transaction to fail. As such, it is important for Realtors to constantly maintain updated calendars in order to track all transactions so as to avoid missing any due dates. However, due to the complexity of the real estate business, proper tracking and maintenance of real estate transaction information has not been successful.

Generally, real estate transactions are approached from two different vantage points: 1) offering a property for sale to the general public on behalf of a person owning the property; and 2) seeking a property on behalf of a person desiring to acquire it, wherein the property can be commercial, residential, industrial or other types of property and wherein the person can be a single person, multiple people, businesses, corporations or other parties acquiring a property. The first vantage point focuses on the sale of a subject property, while the second vantage point focuses on the purchase of a subject property.

From the first vantage point, the seller, who can be the owner, lien-holder or other interested party of a subject property, often hires a listing Realtor who markets and advertises the subject property to prospective buyers, wherein “prospective buyers” can include a single person, multiple people, businesses, corporations, their agents or other parties seeking a real estate property. The listing Realtor, who is hired by the seller, often provides in their marketing and advertising materials information, such as functional characteristics of the property, which can include a property's offering price, size and location, as well as other pertinent information for prospective buyers.

Often, the listing Realtor will also provide the seller with information regarding prospective buyers who have exhibited interest in the property, such as their opinions or comments, as well as any contractual offers and acceptances. The listing Realtor will also provide the seller with information during the marketing and advertising process regarding actions performed by the listing Realtor on behalf of the seller. However, in order to keep the seller well informed, the listing Realtor must constantly be in contact with the seller. This high level of contact must also be maintained until the final closing on the subject property. This constant contact can often be inconvenient and disruptive to maintain for both the Realtor and the seller. Therefore, a better method of managing and transferring real estate transaction information is desired.

From the second vantage point, a buyer often hires a buyer's agent (i.e., Realtor) to find, negotiate and help buy a property for the buyer. After a contract has been successfully negotiated and accepted by both the seller and the buyer (a ratified contract), the buyer relies on the buyer's agent to keep the buyer informed of all requirements of the contract, including completed or upcoming due dates, in order to successfully transfer title of the property from the seller to the buyer. As such, both the listing Realtor and the buyer's agent must monitor all contractual tasks from the ratification date through the settlement date on behalf of the seller and the buyer. Additionally, the listing Realtor and the buyer's agent must also monitor all of the contractual tasks from the ratification date to the settlement date on behalf of the seller and the buyer, respectively.

Due to the important nature, and time sensitivity of the various tasks, a reliable, constantly updating information managing and transferring system is desired.

### SUMMARY OF THE INVENTION

An object of the invention is to solve at least the above problems and/or disadvantages and to provide at least the advantages described hereinafter.

In order to achieve at least the above objects in whole or in part, and in accordance with the purpose of the invention, as embodied and broadly described, there is provided a real estate information managing and transferring system accessible by multiple parties, which include sellers, buyers and Realtors, including a host server with a folder module adapted to contain information about a real estate property or transaction, a reports module communicatively coupled to the folder module, wherein the reports module is adapted to search and filter information from the folder module, and an activity map module communicatively coupled to at least one of the folder module and the reports module, wherein the activity map module comprises a data base of stored features and is adapted to extract information from at least one of the folder module and the reports module and manipulate the extracted information using the stored features to provide docketing information and calendaring functions to the multiple parties, which include sellers, buyers and Realtors, wherein the stored features comprise at least one of a calculator to calculate due dates, a hyperlink to allow connecting between the folder module, the reports module and the activity map module, an automatic file saver, a new activity entry generator, a letter campaign generator, an instruction adding generator, and a note generator, and a display interface.

To further achieve at least the above objects in whole or in part, and in accordance with the purpose of the present invention, as embodied and broadly described, there is provided a computer-implemented method of generating information for real estate management, including entering information regarding a real estate transaction into a folder module, compiling and filtering the information regarding the real estate transaction into a reports module communicatively coupled to the folder module, and automatically generating a calendar of activities and due dates from the information in the folder module and the reports module.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements, wherein:

FIG. 1 is a schematic diagram of a real estate transaction system in accordance with an embodiment of the invention;

FIG. 1A is a schematic diagram of an information managing and transferring system in accordance with an embodiment of the invention;

FIG. 1B is a schematic diagram of a listing database of an information managing and transferring system in accordance with an embodiment of the invention;

FIG. 1C is a schematic diagram of a contact database of an information managing and transferring system in accordance with an embodiment of the invention;

FIG. 1D is a schematic diagram of a site database of an information managing and transferring system in accordance with an embodiment of the invention;

FIG. 2 is a schematic diagram of a folder module in accordance with an embodiment of the invention;

FIG. 3 is a schematic diagram of a reports module in accordance with an embodiment of the invention;

FIG. 4 is a schematic diagram of an activity map module in accordance with an embodiment of the invention;

FIG. 5 is a schematic diagram of a showings module in accordance with an embodiment of the invention;

FIG. 6 is a schematic diagram of a contact management module in accordance with an embodiment of the invention;

FIG. 7 is a schematic diagram of a reservation module in accordance with an embodiment of the invention;

FIG. 8 is a schematic diagram of a website management module in accordance with an embodiment of the invention; and

FIG. 9 is a schematic diagram of a transaction fee coordinating module in accordance with an embodiment of the invention.

### DETAILED DESCRIPTION OF PREFERRED EMBODIMENTS

In the real estate business, in order to keep track of the activities involved in selling, buying, or leasing a property, a real estate information managing and transferring system and method have been developed. In an embodiment of a real estate transaction system of the invention, several modules have been communicatively coupled to provide a complete and reliable system of tracking buyers' and sellers' activities and keeping a Realtor informed and prepared at all times. The real estate managing and transferring system can be made accessible by users, such as Realtors, and can include a host server with communicatively adapted parts to manage and transfer real estate information.

The host server of the real estate managing and transferring system can include a storage section referred to herein as a “folder module,” which can be used to store information about selected real estate properties, as well as an information compiling section referred to herein as a “reports module,” and a scheduling section referred to herein as an “activity map module.” The host server can also include other modules, where the term “modules” is intended include any organized grouping of instructions for a mechanized or computerized device including software for a computer and the programs therein, as well as other types of logic layers or instruction sets that can affect the outcome as instructed.

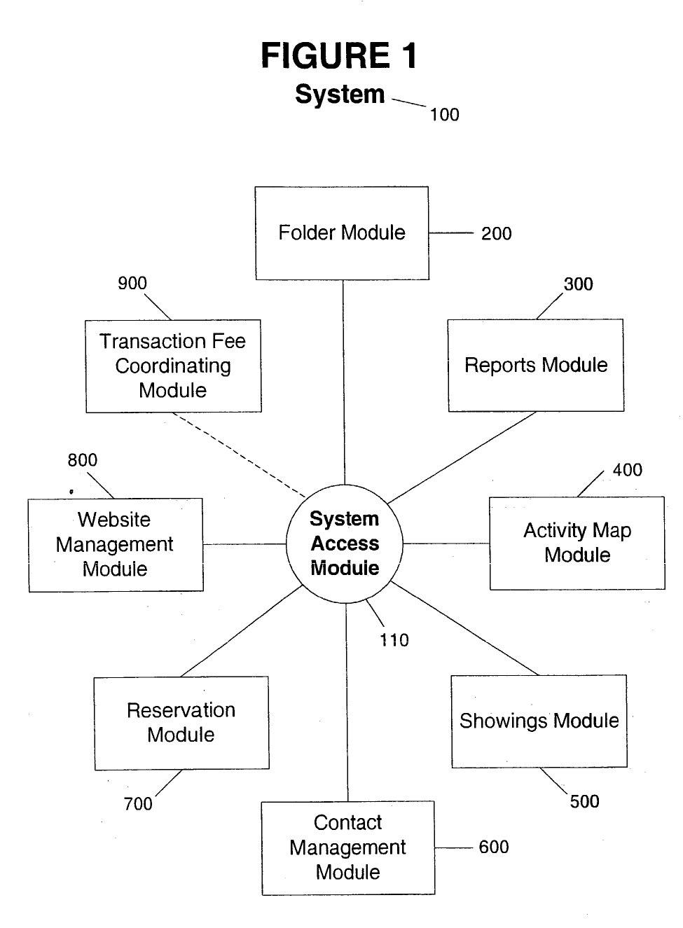

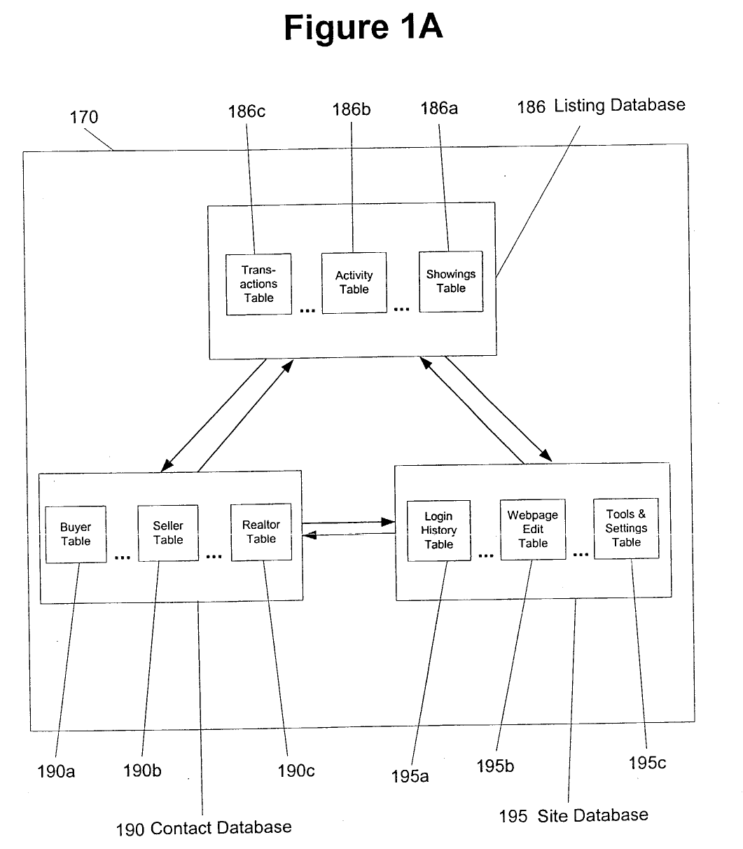

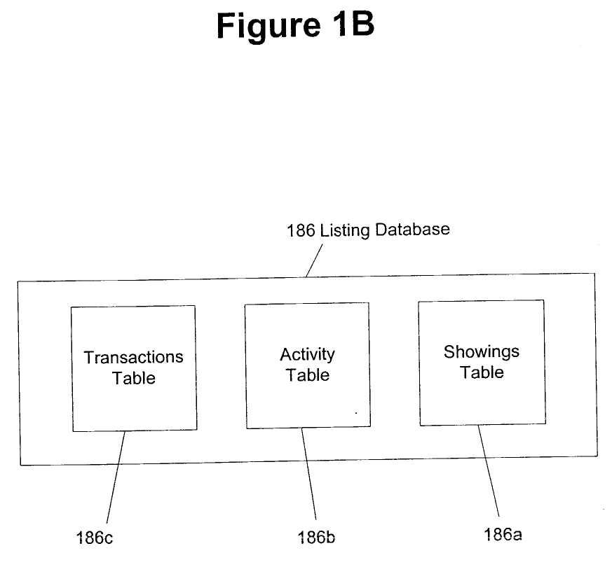

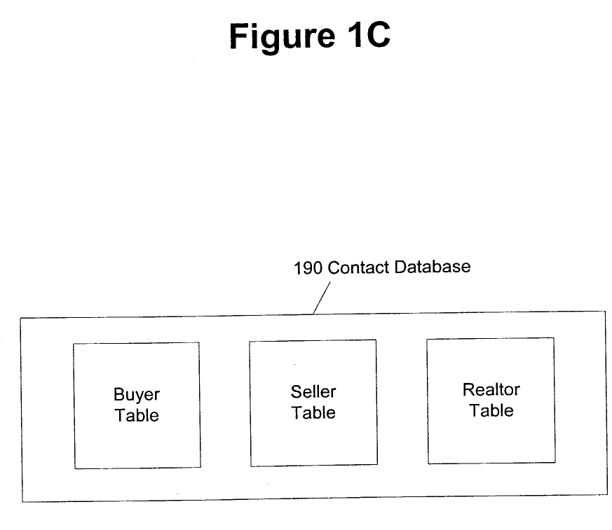

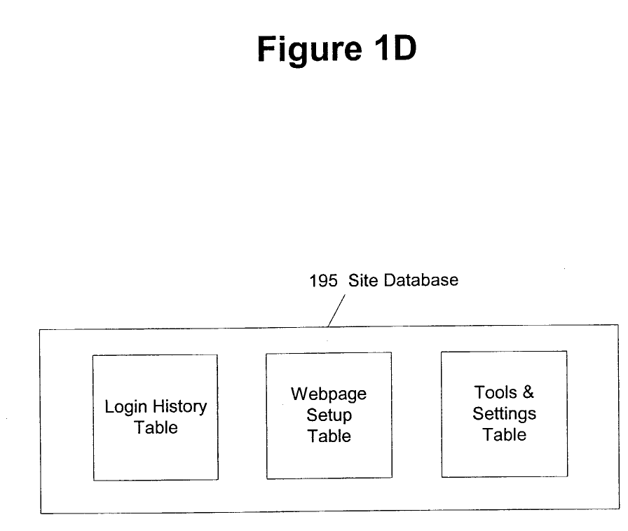

As illustrated in FIG. 1, an information managing and transferring system 100 according to one embodiment of the invention includes a series of modules, including the folder module 200 mentioned above, which are communicatively coupled to a communicative coupler. Numerous modules can be communicatively coupled to the communicative coupler including the folder module 200, the activity map module 400, a showings module 500, the reports module 300, a contact management module 600, a reservation module 700, a website management module 800, and/or a transaction fee coordinating module 900. Other modules not listed may also be provided based on the particular needs of the Realtor/user. Each module may be communicatively coupled to the communicative coupler in order to allow a user of the system to gain access to create, modify and/or delete any information regarding real estate transactions and other pertinent information.

FIG. 1A shows additional detail of the information managing and transferring system 100. As shown in FIG. 1A the the information managing and transferring system 100 preferably includes separate databases that are communicatively coupled and preferably three separate databases. The three databases include a listing database 186, a contact database 190, and a site database 195. Each database preferably includes a set of tables, which allows information to be entered, sorted, stored, compiled, retrieved, and transferred to other ones of the databases according to prescribed criteria. Although three tables are shown in each of the databases, it should be understood that any number of tables could be included. The set of tables may be developed using any standard platform such as Oracle, Cold Fusion, or preferably Lotus Domino. The software code may be written in any standard programming language, such as JavaScript, HTML, C++, or preferably Lotus Script. Once the databases are created they may be communicatively coupled and viewed seamlessly through an interface. The interface may be uploaded to a website and accessed through the Internet. Accordingly, a user who accesses the databases would do so without knowledge that retrieved information was being provided from the separate databases.

Additional information regarding the listing database 186 is next provided. As shown in FIG. 1B, the listing database preferably includes a set of individual tables within the database. The tables may be used to store data information which may be entered manually or automatically. Although the preferred method of storing information is the use of tables, it should be understood that any mechanism of storing fields of information may be used. Each piece of data used to populate the tables is automatically assigned a unique identifier (ID). For example, in the listing database 186, there may be a plurality of tables, such as a showings table 186a, an activity map table 186, and a transaction manager reports table 186c. Each piece of data used by the system is thus organized in an appropriate table in accordance with its unique ID. Preferably, the unique ID is used to retrieve information from the other databases 190, 195. Table information may include transaction information about a house, land, apartment, or any real property for sale, showings information, letter generator information, selling Realtor/buyer feedback/comments information, activities information, and transaction information. The table information may be searched by using a character search or a unique ID search.

Additional detail regarding the contact database 190 is next provided. As shown in FIG. 1C, the contact database 190 preferably includes a plurality of tables. For example, the contact database 190 may include a buyer's table 190a, a seller's table 190b, and a realtor table 190c. Each piece of data used to populate the tables is automatically assigned a unique ID. The data is organized in an appropriate table in accordance with the unique ID. Table information may include separate tables for contact information for Realtors, buyers, sellers, service providers, or any party involved in a real estate transaction. The contact database 190 includes a contact management module, a contact information memory module, a letter generator module, and a contact information automatic updating module. The contact database may also include an equipment reservation module and a rental rules module. The table information may be searched by using a character search or a unique ID search.

Additional information regarding the site database 195 is next provided. As shown in FIG. 1D, the site database 195 preferably includes a plurality of tables. For example, it may include a login history table 195a, a web page edit table 195b, and a tools and settings table 195c. Each piece of data used to populate the tables is automatically assigned a unique ID. The data is organized in an appropriate table in accordance with the unique ID. Table information may include separate tables for information such as user logon information, website management information, a referrals information, a payment information, and/or any other website management information. The table information may be searched by using a character search or a unique ID search.

Each of the three databases 186, 190, 195 preferably interacts with the other's to manage data and generate various reports. For example, the contact database 190 could work in conjunction with the listing database 186 to generate a letter to a potential buyer after a listed property is shown. Additionally, the invoices generated by the listings database 186 could be coupled with letters generated by the contact database 190. It should be understood that any number of fields could be included in each of the databases, and the above descriptions are given by way of example only. Additionally, it should be understood that certain data items are generated by the various databases, and do not need to be entered manually by a user.

Additional information regarding the interconnectivity between the three databases 186, 190, 195 is next provided. As mentioned above, the information entered into the tables of each database is preferably given a unique identifier (ID). This ID is preferably used to identify and authenticate information. The information in each database is made available to the other databases by using a database linking mechanism, which may be provided by any database platform. It should be noted however, that any linking mechanism may be used.

Preferably, all three databases are interconnected by a database link, which is used to search, retrieve, update, and transfer information. In a preferred embodiment of the present invention at least one of the three databases has to be designated a home database. Preferably, the home database is determined by what database contains the most information regarding a specific query. However any method of determining a home database may be used.

Additional information regarding the home database is next provided. The home database receives a user query and translates the user query into a series of unique IDs. The unique IDs are then transmitted from the home database to the other databases using the database link. Each database gathers the pertinent information based on the unique ID. The result of the gathered information from all three databases is then displayed as a cohesive unit, as a response to the user query. It should be noted that any database may designated the home database.

It should be understood that any number of databases could be used to achieve the same functionality. For example, all of the information could be included in a single database and separated into a plurality of tables. Alternatively, more than three databases could be used.

Additional information regarding a user query is next provided. The user may access the web page and enter query information. For example, the web page may store a plurality of information links for a user to choose from. Each information link is considered a query. For example, one such link is a showings information link. This query consists of information residing on all three databases. The showings information link thus may include information such as an image of a house, a realtor's contact information, and price information. Also included may be information regarding what buyers have previously viewed the house and what comments were made regarding the house. Once the link is selected, the home database, which is the listing database 186 in this example, receives, organizes, and translates the query into the series of unique IDs. The listing database 186 then pulls from its tables any information involved with that query. The listing database 186 then retrieves a Realtor contact information through the database link from the contact database 190. The listing database 186 then retrieves a user history log-on and feedback information through a database link from the site database 195. The linking database 186 then compiles the information and preferably displays it by loading it onto the Internet web sites The user can then view the information seamlessly through the web site interface.

Also, the preferred embodiment implements a single sign-on mechanism that coordinates log-ons to all three databases in a computer network with preferably one ID and password. Also included may be a master key used to synchronize a set of information entries made on the databases. The synchronization allows for real time update capabilities. For example, if a user provides updated information via the web site interface, the tables in the listing, contact, and site databases 186, 190, 195 automatically receive and update corresponding information. Thus, a user receives all the necessary information from the individual databases without delay. Any application used in creating the databases may include the single sign on mechanism. For example, Microsoft NT, Oracle, SQL, Lotus Notes, or PeopleSoft. Once a user enters the user name and password information the user query may be entered to retrieve pertinent information from the three databases.

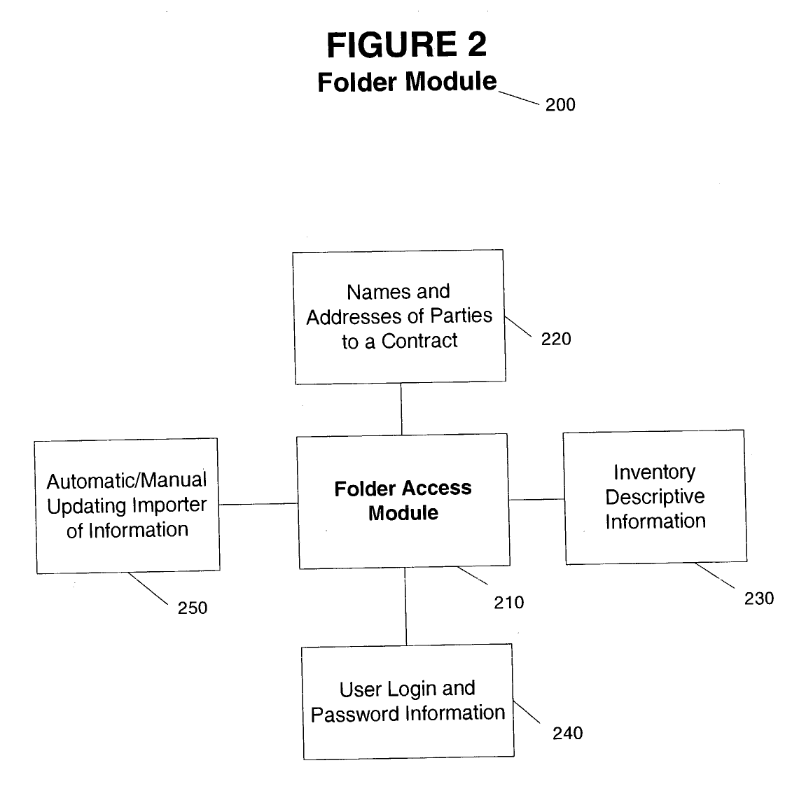

As illustrated in FIG. 2, the folder module 200 contains data for the system 100 which is stored in a manner that enables it to be viewed (or rearranged in some manner) using the other modules in the system 100. The folder module 200 is itself a collection of folders each of which relates to particular real estate transactions. For example, if a piece of property is being sold, a Realtor will create a folder and insert information such as, initially, the name(s) of the seller, and subsequently the buyer, the price, the address, size, terms and conditions, all the due dates, and so forth. The folder module 200 facilitates this process by providing the Realtor with a form or a series of questions to prompt the Realtor for the required information for that transaction. The Realtor using the system 100 would respond by including information on selected real estate properties, such as, names and addresses of a seller and/or buyer 220, property descriptive information 230, as well as, user login and password information 240 for the host system and an automatic or manual updating importer of information 250. Other information may also be provided as desired based on the particular requests or needs of an end user. The folder module 200 may also be used to store and access information on any other parties, such as inspectors, mortgage agents landscapers and companies providing other services. This process varies depending on the real estate transaction at hand.

The property descriptive information 230 in the folder module 200 may include, for example, video images, audio tracks, written description, status information, pricing and other descriptive information. The written description can include the number of similar properties on the market, the number of rooms including the types of rooms, such as the number of bedrooms and bathrooms, a virtual tour of a subject property through video images, dimensions of each room, or a property's map location.

Additionally, some of this information, including but not limited to the offering price and the description, may be altered as necessary to correct or update information, as well as, to account for market conditions. The folder module 200 may also include user login and password information 240 to restrict or limit access to the public, while allowing various levels of access to a Realtor, buyer, seller or other interested party depending upon the user. This can allow a Realtor to control access into the folder module 200 so that only the Realtor can edit information therein, while a buyer, seller or other interested party can only read the information that the Realtor permits them to read.

Finally, the folder module 200 can also include an automatic or manual updating importer of information 250 to automatically or manually update information in the folder module 200 by linking the system to a database independent from the system that may contain updated information.

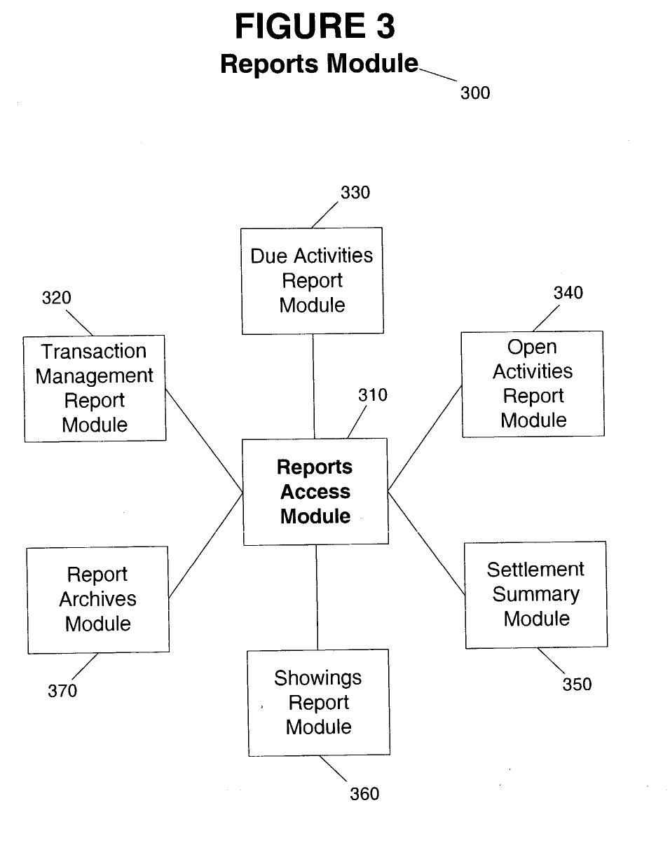

As illustrated in FIG. 3, the reports module 300 contains instructions for the system 100 that enables the data within the folder module 200 to be manipulated into selected groups which can be viewed. The reports module 300 takes the data from the folder module 200 and compiles the data to create customized listings or reports depending on what the user of the system desires. For example, the reports module 300 can allow a Realtor to view all of the data in the folder module 200 in a list or calendar form. The reports module 300 can also filter the data from the folder module 200 to display only certain types of data, such as the data for a particular date, a particular property or a particular type of due date.

The reports module 300 may include a report access module 310, which may be communicatively coupled to a transaction management report (TMR) module 320, a due activities report module 330, an open activities report module 340, a settlement summary module 350, a showings report module 360, a report archives module 370, and/or other reports modules.

The TMR module 320 of the reports module 300 is used to gather and group data from the folder module 200 into individual time management reports. These individual time management reports may include any groupings of data from the folder module including a listing of all transactions that are pending or have been completed, so that a Realtor can have all desired dates grouped into reports defined by the Realtor. Using the TMR module 320, a Realtor can customize reports as lists or calendars to keep track of dates and activities for real estate transactions in any format, thus allowing the Realtor to filter information as needed. In a preferred embodiment, all properties with a Realtor can be listed in a single report, where the Realtor can select fields to display in the report, as well as the order to sort the properties. For example, using the TMR module 320, all properties can be listed in order of settlement date so that any and all prior to and including the settlement date can be emphasized and displayed as a single report.

Additionally, the due activities module 330 can display all activities for every transaction not completed, or settled on a single report in a calendar format which can include a daily, weekly or monthly format, as well as listing responsible parties for each activity. The due activities report may include any type of due activity for a real estate transaction or other activity. The open activities module 340 may be used to compile lists of any activities which are open, do not have due dates, and have not been completed.

A settlement summary module 350 may also be provided in the reports module 300 and may be configured to list information regarding a settlement of a real estate transaction, for example, the parties involved, the property being settled, the lactations of the settlement, settlement dates, and conditions, etc. The settlement summary module 350 can also show, in list, calendar or other desired form, the dates, times and places of all upcoming settlements, in a single report for better scheduling by the Realtor, thus eliminating the possibility of scheduling two closings back-to-back yet in different parts of town. This can also aid in allowing a Realtor to approach each settlement completely prepared.

A showings report module 360 may also be included in the reports module 300. The showings report module 360 may be configured to list the showings of a particular Realtor and any other showings information as necessary.

Finally, the report module 300 may include a report archives module 370. The report archives module 370 may be used to store previously generated reports and can be used to archive reports or data entry from any of the modules communicatively coupled thereto.

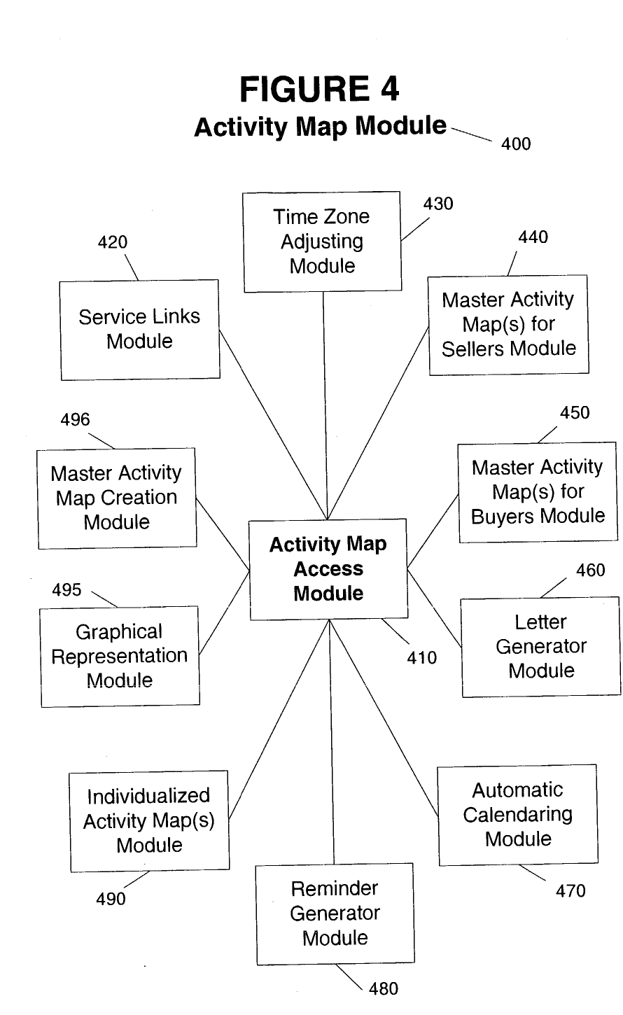

As illustrated in FIG. 4, the activity map module 400 contains instructions for the system 100 for automatically generating activities, and therefore a calendar of activities. The automatic generation of activities calendars can occur because of the often repetitive nature of real estate transactions. For example, closing dates are often set one to two months from contracting, inspection contingencies are often set ten days after contract ratification, etc. As such, the activity map module 400 uses these known repeating contractual terms to instruct the system 100 to automatically generate activities in a calendar based upon data from the folder module 200.

In the activity map module 400, instructions in the forms of templates or “master activity maps” 440, 450 are used for automatically determining due dates and activities based upon one or more due dates that can be extracted from the folder module 200. A date can then be entered into the template to generate other dates and activities for a real estate transaction. For example, in order to create a schedule for closing on a property or “activity map,” a contract offer date can be extracted from the folder module 200 into the activity map module 400. Then, using the contract offer date, the due dates for events, such as home inspections, radon inspections, and mortgage contingencies can be automatically calendared by the activity map module 400 based upon the master activity map.

Additionally, the activity map can be generated manually by entering activities and their corresponding due dates. The activity map module 400 also allows a Realtor to add, change or delete any aspect of an activity either individually for each client or for all clients uniformly.

The master activity map 440, 450 can, in turn, be selected specifically for a buyer or a seller every time a new folder is entered into the system, whereupon the system 100 can create a copy of the master activity map 440, 450 for that client and automatically generate a calendar if one or more real estate transaction dates are known. On the individualized activity map 490, status information for a Realtor and their client can be updated.

The activity map module 400 may include several modules communicatively coupled to an activity map access module 410. For example, the modules may include but are not limited to a service links module 420, a time zone adjusting module 430, a master activity map(s) for sellers module 440, a master activity map(s) for buyers module 450, a letter generator module 460, an automatic calendaring module 470, a reminder generator module 480, an individualized activity map(s) module(s) 490, and a graphical representation module 495.

The activity map module 400 may be used to record notes on a transaction or to create customized messages per activity or add staff instructions per activity. The activity map module 400 may also display all work for an activity in a notes section, add and display notes for each activity map, or display activity maps which may be divided into submaps, which in turn may be individually customized for parties to a real estate transaction.

The activity map module 400 may also be used to add unique, ad hoc activities to individualized activity maps, mark activities with the same or different date and the same or different status, or copy existing activity maps as a baseline in creating new master activity maps 440, 450. Further, the activity map module 400 may also be used to add a service provider link to an individual activity, allow access by other users to other users, or display third-party activity maps. Additionally, the activity map module 400 may be used to view activity maps in list format in addition to graphical format, and create “private” activities which only specific users can access.

A service links module 420 can be provided within the activity map module 400 to provide information on real estate related service providers, such as inspectors, appraisers, contractors, etc., as well as the contact information for these providers as needed. A time zone adjusting module 430 can also be provided within the activity map module 400 to adjust the activity map times for a specific real estate transaction to a different time zone, so that a specific time designated for a specific task can be properly identified no matter which time zone a party is located in.

A letter generator module 460 may also be included in the activity map module 400 and configured to generate letters in the form of, for example, printed communications, email or facsimile communications to, for example, the Realtor, buyer, seller, clients or other parties which the Realtor may wish to contact.

An automatic calendaring module 470 may also be included in the activity map module 400, as shown in FIG. 4. The automatic calendaring module 470 may, for example, be configured to enter dates and tasks into a calendar form as necessary or can automatically calendar other recurring or one time activities or messages from an activity map, as mentioned above.

In addition to the automatic calendaring module 470, the activity map module 400 may also include the reminder generator module 480 which may work in conjunction with the automatic calendaring module 470 and/or master activity maps 440, 450 to create reminders as to tasks, dates and times which may be important. A letter generator module 460 may be utilized to create such reminders.

The activity map module 400 may also include an individualized activity map(s) module 490, as mentioned above, into which a Realtor or other user of the system can enter any activities separate from the real estate transactions, such as to client specific matter as necessary. Additionally, individualized activity maps created by the individualized activity map(s) module 490 can be used to allow a client to view the entire process including activities a client is not involved in as a Realtor deems appropriate. With the individualized activity maps, a client can be better prepared and have a deeper understanding as to a Realtor's activities which do not involve their client, as well as the detailed and overview displays of upcoming and completed activities. Additionally, all of the services provided by the Realtor can be accessed by their client and thus empowering the client to prepare for upcoming activities.

Finally, the activity map module 400 may also include a graphical representation module 495 to allow for any portion of the activity map module to be displayed graphically. For example, graphical representations of upcoming dates and tasks could to be displayed in list or calendar format using the graphical representation module 495.

In addition to the modules discussed above, other modules may be included in the activity map access module, such as, one configured to record notes on a transaction, one configured to add staff instructions per task or activity, or one configured to select either email or printed mail as a media for updating a client with regard to the tasks or activities. Additionally, other modules may also be included, such as, one configured to create letter campaigns for each activity or task, one configured to add new activities as needed, one configured to allow Realtors to view activity maps from a viewpoint of a client, one configured to convert the master activity maps into a list format, and/or one configured to allow a Realtor to create private activities which only the Realtor can view. Other modules may also be appropriate based on the needs of a particular user, Realtor, client, seller and/or buyer, etc.

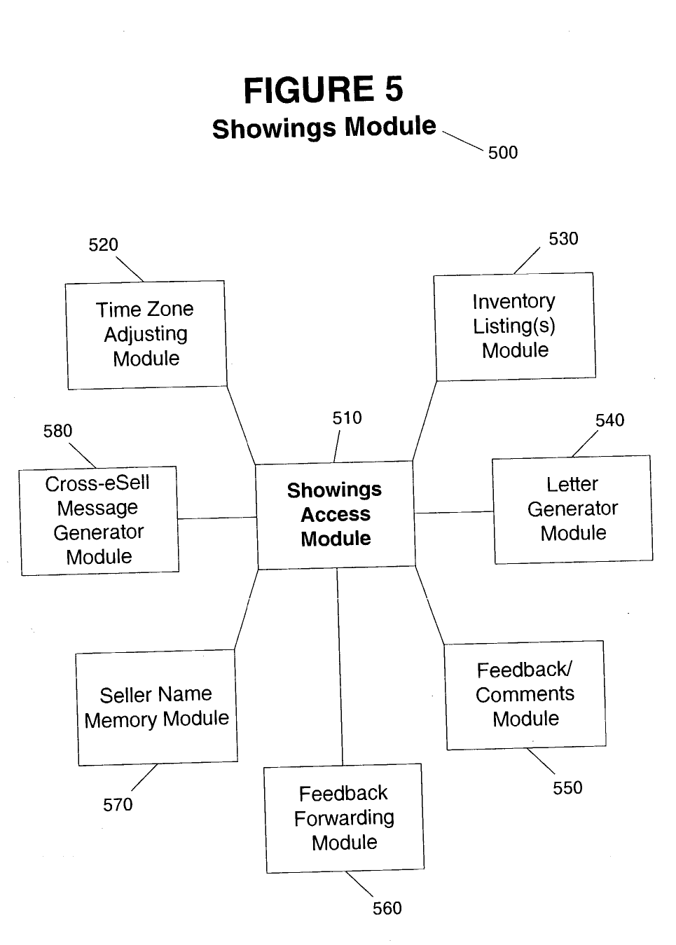

As illustrated in FIG. 5, the showings module 500 contains instructions for the system 100 which helps Realtors better market their property. The showing module 500 gathers information from prospective buyers for a Realtor, compiles this information and then makes the information available to the seller. Preferably, a prospective buyer will tell the Realtor the buyer's opinion about a property, then in turn the buyer's Realtor would tell the seller's Realtor, who, finally, tells the seller, where the showings module 500 facilitates the communication between the Realtors.

The showings module 500 can also be used to provide feedback to a seller from a prospective buyer. For example, if a prospective buyer sees the seller's house and thinks the kitchen is too outdated, the seller can then adjust the price taking this into account, or can remodel the kitchen. Additionally, a seller can use the showing module to compile a list of Realtors who have shown a property and the seller can also broadcast messages to these Realtors regarding price reductions, or other updates, etc.

The showings module 500 works by monitoring for visits to a property by a prospective buyer and requesting feedback from the prospective buyer via email, facsimile, letter or other automated communication. The system can then receive the information and can send related information to the seller via email, facsimile, letter or other automated communication based on the information gathered.

The showings module 500 may include several communicatively coupled modules, such as a showing access module 510, a time zone adjusting module 520 or a real estate listing(s) module 530. The showings module may also include but is not limited to a letter generator module 540, a feedback/comments module 550 or a feedback forwarding module 560. Additionally, the showings module 500 may further include a Realtor name memory module 570, a cross-eSell message generator module 580, and/or other showings related modules. In addition to the time zone adjusting module 430 of the activity map module 400, the showings module 500 may also have a similar time zone adjusting module 520 to ensure proper times are provided for a party located in a different time zone.

A real estate listing(s) module 530 may also be provided in the showings module 500, where the real estate listing(s) module 530 is configured to display a real estate property's information for prospective buyers. Thus, a buyer's agent will save time and effort by allowing a prospective buyer to view all real estate listings available without aid by the Realtor and a prospective buyer benefits in that all properties can be seen without having to physically go to each property in person.

The real estate listing(s) module 530 also allows a prospective buyer to form a better idea of features sought in their ideal property, as well as allows the prospective buyer to discover neighborhoods that might include properties with those features. Also, both a prospective buyer and a buyer's agent, as well as a seller and a seller's agent, would not have to coordinate schedules in order to provide a viewing to a prospective buyer. Rather, a prospective buyer can access property information at any time through the real estate listings module 530.

The showings module 500 may include a cross-eSell message generator module 580, which may be used in real estate transactions to automatically generate messages which can be sent through a letter generator module 540. The cross-eSell message generator module 580 can be used wherever automatic message generators for facilitating an information exchange may be needed. For example, the cross-eSell message generator module 580 can be used to automatically send a Realtor a thank you note and/or provide that Realtor with information on other properties, which may have similar attributes, such as price, style, location, etc.

The cross-eSell message generator module 580 may also be used to automatically generate messages to buyer's agents who access the showings module 500 and can base the messages upon buyer's agent's actions when accessing the showings module 500. Preferably, the cross-eSell message generator module 580 sends a thank you note from the seller's Realtor to the buyer's Realtor to thank them for taking the buyer to the property and along with the thank you note, also sends other properties listed by the seller's Realtor that are similar in price, location, or other attribute to the property already shown.

The showings module 500 may also include a feedback/comments module 550 through which a selling Realtor or other interested party may provide feedback or comments to a listing Realtor to keep the listing Realtor informed of any visits by any customers, such as a selling Realtor or a buyer. A feedback forwarding module 560 may also be included in the showings module 500 and may be configured to forward the feedback or comments from the feedback/comments module 550 to the listing Realtor and then the seller through the letter generator module 540. This increases both the ease of entry of feedback, as well as the accessibility to that feedback.

The showings module 500 may also include a Realtor name memory module 570 configured to record any visit by a particular Realtor. Thus, if a Realtor shows a property the system will record the visit so that if a Realtor shows a property more than once, the listing Realtor will know of the multiple visits, as well as any recorded information regarding the Realtor who has just seen the property, such as any previous visits to either a particular property or other properties visited in the past.

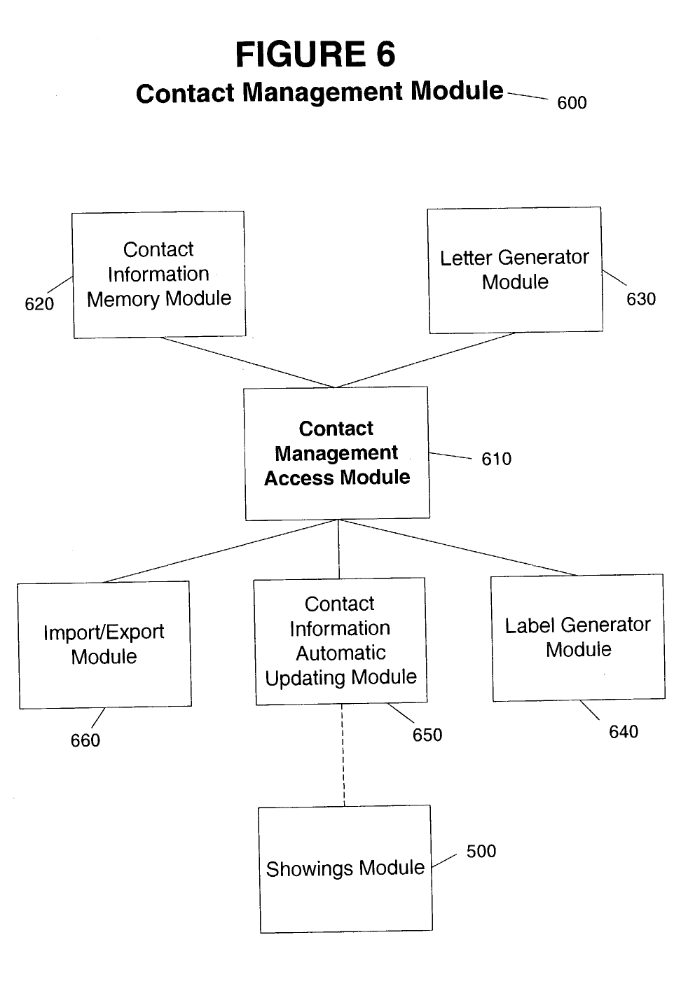

In addition to the above-mentioned modules, as illustrated in FIG. 6, the contact management module 600 is similar to the folder module, but instead of containing data on real estate transactions, it separately contains contact information data for parties related to a property transaction. The contact management module 600 allows Realtors to store the names, addresses, phone numbers, etc. for parties to a transaction, as well as other contacts that may be helpful in the Realtor's business, such as lenders, home inspection companies, tide companies, settlement companies, etc. For example, whenever a house is purchased, a title company must be employed and the contact information from the tide company must be kept separate from the folder module 200 as each house purchase will need this information.

The contact management module 600 may include a contact management access module 610 communicatively coupled to a contact information memory module 620, a letter generator module 630, a label generator module 640, a contact information automatic updating module 650, and/or any other contact management information as necessary. The contact information memory module 620 may be used to store any contact information of any parties to the contract, vendors necessary for the completion of the contract, other interested parties, levels interest or importance of the contact, categories of contacts, etc.

The contact management module 600 may also include a letter generator module 630, which may be used to merge pre-written form letters or personal letters with the contact information in the contact management module 600 where the letters are addressed and sent to parties using the contact management module. The contact management module 600 may also include a separate label generator module 640 configured, preferably, to generate labels with the contact information stored in the contact information memory of the contact management module 600. The letter generator module 630 can also be used for a letter campaign, where mass mailings can be sent to any or all of the contacts, including groupings of contacts, in the contact management module 600, where each letter can be traded to determine what letters have been sent to which contacts, as well as which letters are yet to be sent or yet to be opened.

Finally, the contact management module 600 may also include a contact information automatic updating module 650, which may be used either by the Realtor running the system or by anyone the Realtor allows access. In turn, the contact information automatic updating module 650 can be linked to the contact information memory module 620 to allow for automatic updating of information as needed. The updated contact information can be added manually or from another source, such as e-mails, Realtor's listings, etc.

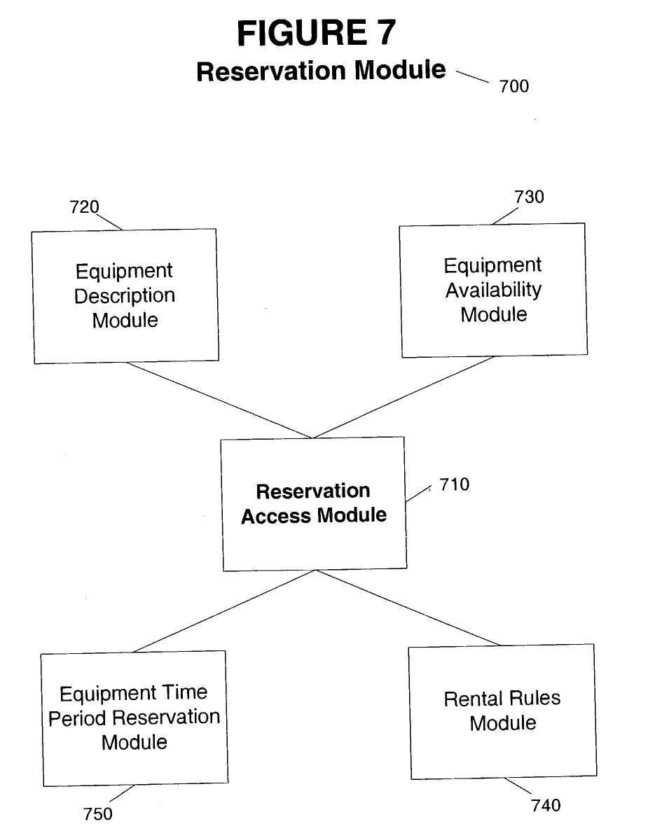

As illustrated in FIG. 7, a reservation module 700 is where reservations for moving equipment are made. The reservation module contains a data base of equipment that a buyer or seller can reserve for moving, cleaning or any other purpose as needed. The reservation module also contains a scheduling calendar which displays when each piece of equipment is already reserved or available for use. For example, using the reservation module 700, a buyer can access this calendar to reserve a moving truck for the day after the purchase of a house. The reservation module can also include equipment from outside vendors as the Realtor deems necessary.

A preferred embodiment of the reservation module 700 may include a calendar which displays equipment availability based upon the date of the calendar and also includes editing tools to adjust the availability of the equipment. The Realtor can allow unrestricted access or can allow restricted access by using the website management module 800 to preauthorize a guest to access this module 700.

The reservation module 700 may include a reservation access module 710 communicatively coupled to a rental rules module 740, an equipment description module 720, an equipment availability module 730, an equipment time period reservation module 750, or any other module necessary for reservations. In the reservation module 700, the rental rules module 740 may include any applicable rules, such as the maximum time for which a person can rent the equipment, specific minimum age requirements for the driver, deposit requirements, etc. The equipment description module 720 may include information relevant to particular equipment available, such as the size of the equipment, the amount of deposit required, the size of the storage area, etc. The equipment availability module 730 may include a calendar or a listing configured to display available dates for which equipment may be reserved. Finally, the equipment time period reservation module 750 may include any reserved equipment time period.

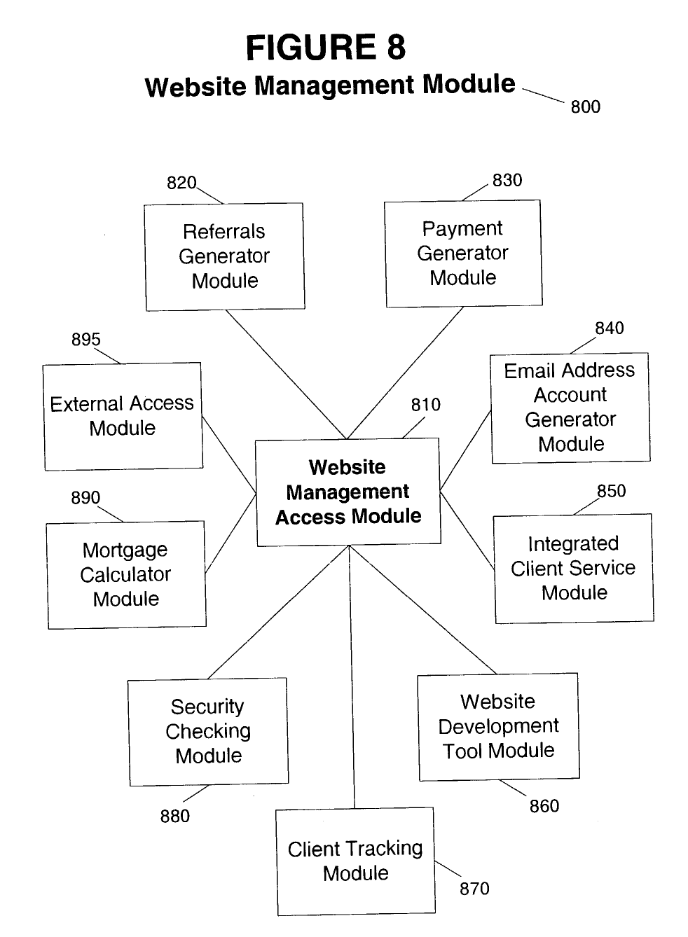

As illustrated in FIG. 8, the website management module 800 contains a website development tool for helping a Realtor change their website. The website management module 800 provides an easy to use template that Realtors can use to edit the content, format and style, such as their website's background colors, fonts, layout and so on. A Realtor can also use the website management module 800 in conjunction with other modules. For example, a Realtor can add to their website new displays of real estate properties by importing the data from the folder module 200 or can add feedback from the showings module 500 to their website. The Realtor can also provide hyperlinks to various modules of the system 100 to provide easier access to each part of the system as needed. For example, for the Realtor's own use, the Realtor could provide a hyperlink to the folder module 200 from a main home page for better navigation within the website.

The website management module 800 may include a website management access module 810 communicatively coupled to a referrals generator module 820, a payment generator module 830, or an email address account generator module 840. The website management module 800 may also include an integrated client service module 850, website development tool module 860, a client tracking module 870, or a security checking module 880. Finally, the website management module 800 may also include a mortgage calculator module 890, an external access module 895, and/or any other website management module.

The website management module 800 may be a template-based website development tool controlled by a Realtor which can be used to add, change or delete any properties of their website. The website management module 800 may also be used to make contact with potential new clients, allow control over individual folders, folder activity maps, individual contacts or change the accessibility rules or authorized users.

The website management module 800 may also be used to allow the website owner Realtor to pay for the costs of the system, post testimonials directly to the system or track and date clients logged into a Realtor's website. Further, the website management module 800 may allow a Realtor interaction with system administrators, add or delete email accounts without intervention from system administrators, add unlimited numbers of levels of content, or add downloadable files to each of a Realtor's websites, use hyperlink files as sidebar titles.

The website management module 800 can also allow a user to require visitors to provide an email address or other pertinent identification prior to viewing portions of the website or allow a user to link forms to other areas in their websites. Furthermore, the website management module 800 may also allow a user to grant service providers access to each service provider's contact information, allow a user to navigate a help system more easily, or allow a user to grant their clients access to each client's contact information.

The website management module 800 can also allow access to a mortgage calculator anywhere in the Realtor's website, highlight the Realtor's mailing address, or display affiliate banners. The website management module 800 can also allow for pictures to act as a website link, allow service providers to sign up directly on each Realtor's website, print user manuals to take on listing appointments, or display all incoming leads posted to the Realtor's inbox.

The website management module 800 can also allow service providers to add pictures to their entries, allow users online access to their account information, and allow users to designate different amounts to charge their respective service providers.

A referrals generator module 820 may be provided in the website management module 800. The referrals generator module 820 may be configured, for example, to make referrals of a Realtor or a client to other service providers or to retail providers, as needed.

A payment generator module 830 may also be provided in the website management module 800. The payment generator module 830 may be configured, for example, to collect payment or generate invoices for usage of the real estate transaction system, as needed.

An email address account generator module 840 may also be provided in the website management module 800. The email address account generator module 840 may be configured to create, edit or remove email addresses, as needed.

An integrated client service module 850 may also be provided in the website management module 800. The integrated client service module 850 may be configured, for example, to provide client services, such as to provide client user manuals to take on listing appointments, automatically update information regarding the transaction or the parties to the transaction, automatically depending from interaction by the parties.

Additionally, the integrated client service module 850 may also be used to customize forms with auto-responding e-mails. For example, using the integrated client service module 850, pre-built forms, such as requests for information or requests for services can be included. These “client-capture” forms can be used to find new clients, as well as allow prospective clients to communicate with the system administrator directly.

The website development tool module 860 may also be provided to allow a user of the system to alter the website. In a preferred embodiment, the website development tool module 860 can be used to implement a template-based website development tool allowing for any changes within the website. The website development tool module 860 may also be configured to control individual folders, activity maps or contracts, or allow Realtors to interact with another party. The website management module 800 may also add or delete email accounts, add downloadable files, allow visitors to provide information, allow Realtors to link forms to other areas, and/or display all incoming leads posted to a Realtor.

A client tracking module 870 may also be provided in the website management module 800. The client tracking module 870 may be configured, for example, to determine whether a client has entered a website and if so where the client has gone within the website, the time and frequency, as well as content.

A security checking module 880 may also be provided in the website management module 800. The security checking module 880 may be configured to deny entry to users who are not authorized to use the website.

The website management module 800 may also include a mortgage calculator module 890, which may be configured to calculate monthly payments from the total cost of a real estate transaction and/or to calculate a total cost of a real estate transaction from a monthly allotment and an external access module 895, which may be configured to allow external access by a Realtor, client and/or other parties from any external site.

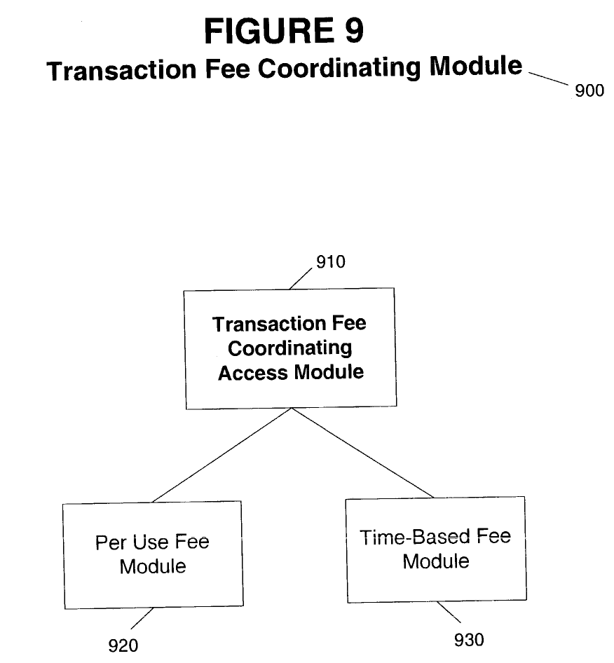

As illustrated in FIG. 9, the transaction fee coordinating module 900 can be used to calculate the charges for using the system 100. The transaction fee coordinating module 900 can be used track the amount of usage based on time or other factors and charge based upon those factors. For example, the system 100 can be used to track transactions and calculate the charges based on the number and/or type of transactions. The transaction fee coordinating module 900 can also be used to display the charges accumulated or the charges that a transaction will cost prior to use of the system. The transaction fee coordinating module 900 can also be used to calculate the total charges for a Realtor using the system per use or per time period and can allow the Realtor access to review and pay the charges, as needed.

The transaction fee coordinating module 900 may include a transaction fee coordinating access module 910 communicatively coupled to a per use fee module 920, a time-based fee module 930, and/or other transaction fee coordinating related modules. Alternately, this module may be replaced with a flat fee module which may generate invoices or make automatic deductions based on a set fee. The per use fee module 920 may be configured to calculate fees, generate invoices or make automatic deductions from an account based on a predetermined schedule of fees that may be levied. The time-based fee 930 module may be configured to calculate fees, generate an invoice or automatic deduction from a Realtor by the system based on a predetermined rate per unit time.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A real estate information managing and transferring system accessible by multiple parties, which include sellers, buyers and Realtors, comprising:
a host server, comprising:
a folder module adapted to contain information about a real estate property or transaction;
a reports module communicatively coupled to the folder module, wherein the reports module is adapted to search and filter information from the folder module; and
an activity map module communicatively coupled to at least one of the folder module and the reports module, wherein the activity map module comprises a data base of stored features and is adapted to extract information from at least one of the folder module and the reports module and manipulate the extracted information using the stored features to provide docketing information and calendaring functions to the multiple parties, which include sellers, buyers and Realtors, wherein the stored features comprise at least one of a calculator to calculate due dates, a hyperlink to allow connecting between the folder module, the reports module and the activity map module, an automatic file saver, a new activity entry generator, a letter campaign generator, an instruction adding generator, and a note generator; and
a display interface.

2. A computer-implemented method of generating information for real estate management, comprising:
entering information regarding a real estate transaction into a folder module;
compiling and filtering the information regarding the real estate transaction into a reports module communicatively coupled to the folder module; and
automatically generating a calendar of activities and due dates from the information in the folder module and the reports module.

3. The system of claim 1, wherein the stored features comprise a calculator to calculate due dates, wherein the calculator receives information about the real estate transaction from at least one of the folder module and reports module and manipulates the information to incorporate due dates for a real estate transaction into a calendar.

4. The system of claim 1, wherein the stored features comprise a hyperlink to allow connecting between the folder module, wherein the hyperlink is presented on a display screen adapted for displaying predetermined information about a real estate transaction and wherein when the hyperlink is activated, the display screen will switch the display from displaying one of the folder module, the reports module or the activity map module to displaying a different one of the folder module, the reports module or the activity map module.

5. The system of claim 1, wherein the stored features comprise an automatic file saver, wherein when a predetermined time elapses, all entries in the folder module, the reports module and/or the activity map module are automatically stored.

6. The system of claim 1, wherein the stored features comprise a new activity entry generator, wherein the new activity generator allows new activities to be entered into the real estate management system and the folder module, the reports module and/or the activity map module.

7. The system of claim 1, wherein the stored features comprise a letter campaign generator, wherein the letter campaign generator compiles a list of prospective interested parties and generates letters, which include real estate information from the folder module and/or reports module, to each of the prospective interested parties.

8. The system of claim 1, wherein the stored features comprise an instructions adding generator, wherein the instructions adding generator allows for multiple parties, which include sellers, buyers and Realtors to incorporate additional instructions in at least one of the folder module, the reports module or the activity map module for display to a display monitor.

9. The system of claim 1, wherein the stored features comprise a note generator, wherein the note generator allows for multiple parties, which include sellers, buyers and Realtors, to incorporate notes into at least one of the folder module, the reports module or the activity map module for display to a display monitor.

10. The system of claim 1, further comprising a showings module communicatively coupled to at least one of the folder module, the reports module, and the activity map module, wherein the showings module is adapted to manage an information exchange between a prospective buyer and a seller and compiles information from the at least one of the folder module, the reports module, and the activity map module, based upon information provided by a prospective buyer.

11. The system of claim 10, wherein the showings module tracks information entered by a real estate agent.

12. The system of claim 10, wherein the showings module compiles information from at least one of the folder module, the reports module, the activity map module and the showings module, determines specific interests of prospective parties and sends the compiled information to other users based upon the specific interests of prospective parties.

13. The system of claim 12, wherein the specific interests of prospective parties comprise real estate property information and changes in the real estate property information.

14. The system of claim 13, wherein the real estate information comprises price, size, location, and sale status information and changes in real estate prices and sale status.

15. The system of claim 10, wherein the showings module further comprises at least one of a note recorder, an automatic feedback and comments receiver and display, and a hyperlink to at least one of the folder module, the reports module, and the activity map module.

16. The system of claim 1, wherein the reports module comprises at least one of a transaction management report, an all due activities display, an all open activities display, a settlement summary display, an all showings display, a folder archive, a folder organizer and a folder detail compiler.

17. The system of claim 16, wherein the reports module comprises a transaction management report, wherein the transaction management report comprises a display indicating current and past due activities.

18. The system of claim 16, wherein the reports module comprises an all due activities display, where in the all due activities display comprises an appointment adding feature, wherein the appointment adding feature can add features not correlated to a real estate transaction, and a display indicating current and past due activities.

19. The system of claim 1, wherein the folders module comprises an electronic repository for static information about a real estate transaction.

20. The system of claim 19, wherein the static information comprises at least one of names and addresses of participants to a contract, types of participants to the real estate transaction, hypertext links to at least one of the reports module and activity map module, offering price and descriptive physical information about property subject to the real estate transaction.

21. The system of claim 20, wherein the descriptive physical information about the property subject to the real estate transaction comprises at least one of number of bedrooms and bathrooms, room dimensions, map location, pictures or video images of the property subject to the real estate transaction and acreage.

22. The system of claim 19, wherein the folders module is communicatively coupled to external sources which produce multimedia presentations of a property of the real estate transaction, or list and publicize the property of the real estate transaction.

23. The system of claim 1, further comprising a website management module communicatively coupled to at least one of the folder module, the reports module or the activity map, wherein the website management module comprises a website development tool capable of adding, changing or deleting any content or style within a website.

24. The system of claim 23, wherein the website management module comprises at least one of a template-based website development tool, a referral program tool, host system editing tool, a payment manager, a testimonial entry tool and a communication tool.

25. The system of claim 1, further comprising a contact management module communicatively coupled to at least one of the folder module, the reports module or the activity map module, wherein the contact management module stores contact information.

26. The system of claim 25, wherein the contact management module comprises a repository of contact information for other participants to a real estate transaction.

27. The system of claim 26, wherein the other participants include real estate agents, real estate brokers, lenders, home inspection companies, real estate attorneys and title companies.

28. The system of claim 1, further comprising a reservation module communicatively coupled to at least one of the folder module, the reports module or the activity map module, wherein the reservation module comprises a calendar to display equipment availability and editing tools to adjust the availability of the equipment.

29. The system of claim 1, further comprising a transaction fee coordinating module communicatively coupled to at least one of the folder module, the reports module or the activity map module, wherein the transaction fee coordinating module comprises a usage tracking means, a usage time tracking means and a cost calculator, wherein the transaction fee coordinating module determines whether a user is transaction fee based and if so, calculates a transaction fee based upon the amount of usage and time of usage.
